(19) United States
(12) Patent Application Publication
(10) Pub. No.: US 2023/0113990 A1
(43) Pub. Date: Apr. 13, 2023

(54) NUTRITIONAL DRINK

(71) Applicants: Daniel E. Bucci, Plainville, CT (US); Noel J. Collier, Lebanon, CT (US)

(72) Inventors: Daniel E. Bucci, Plainville, CT (US); Noel J. Collier, Lebanon, CT (US)

(21) Appl. No.: 18/065,136

(22) Filed: Dec. 13, 2022

Related U.S. Application Data
(63) Continuation-in-part of application No. 17/687,615, filed on Mar. 5, 2022.
(60) Provisional application No. 63/216,248, filed on Jun. 29, 2021.

(51) Int. Cl. A23L 2/04; A23L 2/60; A23L 2/56; A23L 2/44; A23L 2/52

(52) U.S. Cl. CPC A23L 2/04; A23L 2/60; A23L 2/56; A23L 2/44; A23L 2/52

(57) ABSTRACT

The present disclosure describes a beverage that includes an edible solvent (such as, water) and an extract from one or more sage strains comprising Salvia lavandulifolia. The present disclosure further describes methods of making the beverage, as well as methods of using the beverage.

### CROSS-REFERENCE TO RELATED APPLICATIONS

The present disclosure is a continuation-in-part of U.S. patent application Ser. No. 17/687,615, filed 5 Mar. 2022, which claims priority to and the benefit of U.S. Provisional Patent Application No. 63/216,248, filed 29 Jun. 2021, both of which are incorporated by reference herein in their entirety for all purposes.

### FIELD OF THE INVENTION

The description provides novel nutritional beverages and associated methods of use. The nutritional beverages are potentially useful to ameliorate, relieve, cure, or prevent diseases or disorders, such as one or more symptom of a disease or disorder.

### BACKGROUND

Studies shown the acute and chronic side effects of certain kinds of functional water and/or energy drinks. For example, energy drinks tend to be loaded with artificial sweeteners and/or excessive amounts of added sugar, which can cause adverse health effects over time. Furthermore, some energy drinks have been shown to overwork the heart, while others have been shown to result in a metabolic crash.

It is also well-recognized that the addition of vitamins and minerals to beverages is problematic. For example, vitamins and minerals have poor solubility, stability, and bioavailability when added to beverages and often result in a beverage that has an unpleasant appearance and/or taste.

Thus, there is a need for a beverage that is potentially useful to ameliorate, relieve, cure, or prevent one or more symptoms of diseases or disorders. The present disclosure solves this unfulfilled need by providing nutritional beverages comprising a blend of Spanish sage and/or sage, and methods of using the same.

### SUMMARY

The present disclosure describes novel nutritional beverages that potentially ameliorate, relieve, cure, or prevent one or more symptoms of a disease or disorder. In particular, the present disclosure provides a beverage or nutritional beverage comprising an edible solvent (e.g. water) and an extract from one or more sage strains comprising Salvia lavandulifolia (e.g., an extract from the leaves of one or more sage strains comprising Salvia lavandulifolia). In any aspect or embodiment described herein, the one or more sage strains comprises a mixture of sage strains (e.g., 2, 3, 4, 5, 6, 7, or more sage strains). In any aspect or embodiment described herein, the one or more sage stains further comprises one or more of the following Salvia apiana, Salvia officinalis, or a mixture thereof.

In a further aspect, the present disclosure provides a beverage or nutritional beverage produced according to the process: adding boiling edible solvent (e.g. water) and one or more course-cut sage strains (e.g., about 1 mm to about 10 mm or about 4 mm to about 10 mm) comprising Salvia lavandulifolia to a container; and steeping (e.g., for about 5 minutes to about 30 minutes, about 8 to about 15 minutes, or about 10 minutes) the one or more course-cut sage stains in the edible solvent to produce a first sage extract.

In yet a further aspect, the present disclosure provides a method of making a beverage or nutritional beverage, the method comprising adding boiling edible solvent (e.g. water) and one or more course-cut sage strains (e.g., about 1 mm to about 10 mm or about 4 mm to about 10 mm) comprising Salvia lavandulifolia (e.g. further comprises Salvia apiana, Salvia officianalis, or a mixture thereof) to a container; and steeping (e.g., for about 5 minutes to about 30 minutes, about 8 to about 15 minutes, or about 10 minutes) the one or more course-cut sage stains in the edible solvent to produce a first sage extract.

In another aspect, the present disclosure provides a method for treating or ameliorating a disease, disorder, or one or more symptom of a disease or disorder, in a subject or patient (e.g. an animal such as a human), the method comprising administering to a subject in need thereof a beverage or nutritional beverage described herein, wherein the beverage or nutritional beverage is effective for treating or ameliorating the disease, disorder, or one or more symptom of a disease or disorder in the subject.

In an additional aspect, the present disclosure provides a method of treating a patient (such as a human patient) in need for a disease state or condition, the method comprising administering to a patient in need an effective amount of a nutritional beverage according to the present disclosure.

In another aspect, the description provides a beverage or nutritional beverage of the present disclosure for use in a method of treating a disease or disorder in a subject, the method comprising administering the beverage to a subject in need thereof, wherein the beverage is effective in treating or ameliorating at least one symptom of the disease or disorder.

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the disclosure may be utilized in numerous combinations, all of which are expressly contemplated by the present description. These additional aspects and embodiments are expressly included within the scope of the present disclosure. The publications and other materials used herein to illuminate the background of the disclosure, and in particular cases, to provide additional details respecting the practice, are incorporated by reference.

### DETAILED DESCRIPTION

The following is a detailed description provided to aid those skilled in the art in practicing the present disclosure. Those of ordinary skill in the art may make modifications and variations in the embodiments described herein without departing from the spirit or scope of the present disclosure. All publications, patent applications, patents, figures, and other references mentioned herein are expressly incorporated by reference in their entirety.

Presently described are compositions and methods that relate to the surprising and unexpected discovery that the beverage of the present disclosure. Thus, an aspect of the present disclosure relates to a beverage or nutritional beverage comprising an edible solvent (e.g. water) and an extract from one or more sage strains comprising Salvia lavandulifolia (e.g., an extract from the leaves of one or more sage strains comprising Salvia lavandulifolia). For example, in any aspect or embodiment described herein, the one or more sage strains comprises a mixture of sage strains (e.g., 2, 3, 4, 5, 6, 7, or more sage strains). In any aspect or embodiment described herein, the one or more sage stains further comprises one or more of the following Salvia apiana, Salvia officianalis, or a mixture thereof.

Benefits of the beverage of the present disclosure includes, but not limited to, one or more of: (1) lowers the risk of cancer; (2) improves brain function and memory; (3) lowers total cholesterol and low-density lipoprotein (LDL or bad) cholesterol, as well as raises high-density lipoprotein (HDL or good) cholesterol; (4) supports oral health with antimicrobial properties that kill and/or inhibit microbes that are associated with the growth of dental plaque; (5) eases menopause symptoms; (5) reduces blood sugar levels; (6) supports memory and brain health; (7) supports bone health; (8) helps skin from aging; (9) alleviates diarrhea; and (10) combinations thereof. Benefits of the beverage of the present disclosure relates to, but not limited to, one or more of the following components of the beverage of the present disclosure: (1) high levels of nutrients, vitamins, and/or minerals; (2) caffeic acid, chlorogenic acid, rosmarinic acid, ellagic acid, and rutin; (3) high levels of antioxidants, which help fortify a body's defenses and neutralize potentially harmful free radicals that are linked to chronic diseases; and (4) over 160 distinct polyphenols, which act as antioxidants in a subject's body.

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either both of those included limits are also included in the disclosure.

The following terms are used to describe the present disclosure. In instances where a term is not specifically defined herein, that term is given an art-recognized meaning by those of ordinary skill applying that term in context to its use in describing the present disclosure.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The term “independently” is used herein to indicate that the variable, which is independently applied, varies independently from application to application.

It should also be understood that, in certain methods described herein that include more than one step or act, the order of the steps or acts of the method is not necessarily limited to the order in which the steps or acts of the method are recited unless the context indicates otherwise.

The term “patient” or “subject” is used throughout the specification to describe an animal, preferably a human or a domesticated animal, to whom treatment, including prophylactic treatment, with the compositions according to the present disclosure is provided. For treatment of those infections, conditions or disease states which are specific for a specific animal such as a human patient, the term patient refers to that specific animal, including a domesticated animal such as a dog or cat or a farm animal such as a horse, cow, sheep, etc. In general, in the present disclosure, the term patient refers to a human patient unless otherwise stated or implied from the context of the use of the term.

The term “effective” is used to describe an amount of a compound, composition, or component which, when used within the context of its intended use, effects an intended result. The term effective subsumes all other effective amount or effective concentration terms, which are otherwise described or used in the present disclosure.

Beverages

In an aspect, the description provides a beverage or nutritional beverage comprising an edible solvent (e.g. water) and an extract from one or more sage strains comprising Salvia lavandulifolia (e.g., an extract from the leaves of one or more sage strains comprising Salvia lavandulifolia). In any aspect or embodiment described herein, the one or more sage strains comprises a mixture of sage strains (e.g., 2, 3, 4, 5, 6, 7, or more sage strains). In any aspect or embodiment described herein, the one or more sage stains further comprises one or more of the following Salvia apiana, Salvia officianalis, or a mixture thereof.

In any aspect or embodiment described herein, the solvent or diluent includes, but is not limited to, water, alkaline water, apple cider vinegar, birch water, cactus water, carbonated water, maple water, mineral water, ocean water, spring water, or a mixture thereof.

In any aspect or embodiment described herein, the beverage of the present disclosure includes one or more additive and/or excipient. For example, in any aspect or embodiment described herein, the beverage of the present disclosure includes: (a) one or more (e.g., 1, 2, 3, 4, 5, 6, 7, 8, or more) sweetener, (b) one or more (e.g., 1, 2, 3, 4, 5, 6, 7, 8, or more) flavorant or taste-masking agent, (c) one or more (e.g., 1, 2, 3, 4, 5, 6, 7, 8, or more) colorant, (d) one or more (e.g., 1, 2, 3, 4, 5, 6, 7, 8, or more) solvent or diluent, (e) one or more (e.g., 1, 2, 3, 4, 5, 6, 7, 8, or more) preservative, and (f) a combination thereof.

In any aspect or embodiment described herein, the beverage additive and/or excipient comprises essential oil, cedar oil, chlorophyll, grape seed extract, pine bark oil, resveratrol, vanilla, chia seeds, collagen, fiber (e.g. wheat dextrin, psyllium, methylcellulose, inulin, etc.), acai, amia fruit, artichoke, asparagus, avocado, banana, barley grass, blueberry, beet, blackberry, carrot, celery, cherry, coconut, cordyceps, cranberry, cucumber, fruit juice powder, garlic, ginger root, ginseng, grape, grapefruit, guarana, honey, kale, kava root, lemon, lime, lion's mane, mango, natural flavors, nettle leaf, noni, orange, pineapple, pomegranate, raspberry, reishi, rose, spinach, strawberry, sweet grass, watermelon, wheatgrass, Ashwagandha, black tea, mint, sumac, green tea, lavender, hemp, parsley leaf, matcha, rosemary, sassafras, turmeric, yerba mate, cinnamon, amino acids, caffeine, calcium, carbon, glutathione, electrolytes, cannabidiol (CBD), fulvic acid, protein, sea salt, vitamins, zinc, probiotics, hydrogen, or a mixture thereof.

In any aspect or embodiment described herein, beverage comprises one or more (e.g., 1, 2, 3, 4, 5, 6, 7, 8, or more) sweetener (e.g. stevia leaf extract), one or more (e.g., 1, 2, 3, 4, 5, 6, 7, 8, or more) preservative (e.g. citric acid), one or more (e.g., 1, 2, 3, 4, 5, 6, 7, 8, or more) taste-masking agent (e.g. one or more (e.g., 1, 2, 3, 4, 5, 6, 7, 8, or more) fruit juices, such as one or more fruit juices that includes fruit juice that includes pear juice, white grape juice, apple juice, peach juice, or a mixture thereof), one or more (e.g., 1, 2, 3, 4, 5, 6, 7, 8, or more) antioxidant, one or more (e.g., 1, 2, 3, 4, 5, 6, 7, 8, or more) pH modifier, or a mixture thereof.

For example, in any aspect or embodiment described herein, the beverage of the present disclosure includes a sweetener, which may be useful as taste-masking agent as well, that includes saccharin, aspartame, acesulfame K, neotame, sodium saccharin, sucralose, trehalose, tagatose, mannitol, sorbitol, xylitol, erythritol, maltitol, sucrose, fructose, acacia syrup, alitame, sodium chloride, neohesperidine dihydrochalcone, magnesium chloride, disodium inosinate, sodium L-glutamate, honey, cyclamate, cylamate, dextrose, calcium citrate, glycyrrhizin, sucrose, sugar, monosaccharides, oligosaccharides, aldose, ketose, maltose, lactose, xylitol, D-sorbitol, pentitol, hexitol, malitol, sodium cyclamate, maltol, mannitol, sorbitol, sylitol, isomalt, inulin, Prosweet® Powder, safrole, stevia or stevia leaf extract, thaumatin, talin, monoammonium glyrrhizinate, glucose, or a mixture thereof.

In any aspect or embodiment described herein, the beverage of the present disclosure includes one or more (e.g., 1, 2, 3, 4, 5, 6, 7, 8, or more) taste-masking agent. For example, in any aspect or embodiment described herein, the beverage of the present disclosure comprises a taste-masking agent that includes, but is not limited to, artificial and natural flavorants, citric acid, and sweeteners, including artificial sweeteners, nutritive sweeteners, sugar alcohols, or a mixture thereof.

In any aspect or embodiment described herein, the beverage of the present disclosure comprises one or more (e.g., 1, 2, 3, 4, 5, 6, 7, 8, or more) flavorant or taste-masking agent that includes, but is not limited to, fruit juice. For example, in any aspect or embodiment described herein, the beverage of the present disclosure comprises a flavorant, taste-masking agent, or fruit juice that includes cranberry juice, pomegranate juice, pineapple juice, camerise juice, blackcurrant juice, redcurrant juice, blueberry juice, blackberry juice, strawberry juice, raspberry juice, acai juice, acerola juice, goji berry juice, cynorhodon juice, arbutus juice, myrtle juice, guarana juice, coffee berry juice, cola nuts juice, maracuja juice, goyava juice, mango juice, apple juice, pear juice, peach juice, plume juice, blood-orange grapefruit juice, lemon juice, lime juice, mandarin juice, clementine juice, tangerine juice, or a mixture thereof.

For example, in any aspect or embodiment described herein, the beverage of the present disclosure comprises a flavorant or taste-masking agent that includes, but is not limited to, essential oils, peppermint oil, menthol, spearmint oil, citrus oil, cinnamon oil, strawberry flavor, cherry flavor, raspberry flavor, orange oil, apple, pear, peach, banana, Bavarian cream, caramel, cherry cream, chocolate, cinnamon, bubble gum, citrus, citrus punch, citrus cream, cotton candy, cocoa, cool cherry, camphor, cool citrus, eucalyptus, fruit punch, ginger, spearmint, spearmint cream, glycyrrhetinate, glycyrrhiza (licorice) syrup, grape, lemon, lemon cream, honey-lemon, lemon-lime, lemon-mint, lime, root beer, tutti frutti, walnut, watermelon, rum, anise, black currant, butterscotch, orange, cola, Swiss cream, mandarine, tangerine, grapefruit, vanilla, berry, mixed berry, raspberry, strawberry cream, wild cherry, maple, marshmallow, mint cream, wintergreen, peppermint flavors, peppermint cream, methyl salicylate, eugenol, or a mixture thereof. In any aspect or embodiment described herein, the taste-masking agent includes, but are not limited to, acetaldehyde (apple), benzaldehyde (cherry, almond), cinnamic aldehyde (cinnamon), citral, alpha citral (lemon, lime), neral, beta citral (lemon, lime), decanal (orange, lemon), ethyl vanillin (vanilla, cream), heliotropine, piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), trans-2 hexenal (berry fruits), tolyl aldehyde (cherry, almond), veratraldehyde (vanilla), 2,6-dimethyl-5-heptenal, melonal (melon), 2-6-dimethyloctanal (green fruit), 2-dodecenal (citrus, mandarin), or a mixture thereof.

In any aspect or embodiment described herein, the beverage of the present disclosure optionally contains one or more (e.g., 1, 2, 3, 4, 5, 6, 7, 8, or more) preservative includes citric acid, benzoic acid, sodium benzoate, sorbic acid, sodium carboxymethylcellulose, potassium sorbate, ascorbic acid, or a mixture thereof.

In any aspect or embodiment described herein, the beverage of the present disclosure optionally contains one or more (e.g., 1, 2, 3, 4, 5, 6, 7, 8, or more) antioxidant. For example, in any aspect or embodiment described herein, the beverage of the present disclosure comprises an antioxidant that includes, but is not limited to, butylated hydroxyanisole (BHA), butylated hydroxytoluene (BHT), ascorbic acid, methionine, sodium ascorbate, sodium thiosulfate, sodium bisulfite, sodium metabisulfite, ascorbyl palmitate, thioglycerol, alpha tocopherol (vitamin E), cysteine hydrochloride, or a mixture thereof.

In any aspect or embodiment described herein, the beverage of the present disclosure optionally contains one or more pH modifier. For example, in any aspect or embodiment described herein, the beverage of the present disclosure comprises a pH modifier that includes, but is not limited to, hydrochloric acid, citric acid, fumaric acid, lactic acid, sodium hydroxide, mono sodium phosphate, dibasic sodium phosphate, amino acids, sodium citrate, sodium bicarbonate, sodium carbonate, ammonium carbonate, or a mixture thereof.

In an aspect, the description provides a beverage or nutritional beverage produced according to the process: adding boiling edible solvent (e.g. water and/or such as about 6 ounces to about 10 ounces of edible solvent) and one or more course-cut sage strains (e.g., about 1 mm to about 10 mm or about 4 mm to about 10 mm) comprising Salvia lavandulifolia to a container; and steeping (e.g., for about 5 minutes to about 30 minutes, about 8 to about 15 minutes, or about 10 minutes) the one or more course-cut sage stains in the edible solvent to produce a first sage extract.

In any aspect or embodiment described herein, the one or more course-cut sage strains comprises a mixture of sage strains (e.g., 2, 3, 4, 5, 6, 7, or more sage strains).

In any aspect or embodiment described herein, the one or more cross-cut sage stains further comprises Salvia apiana, Salvia officianalis, or a mixture thereof.

In any aspect or embodiment described herein, there is about 6 ounces to about 10 ounces of edible solvent, about 0.5 to about 2.5 tablespoons of the course cut sage, or a mixture thereof.

In any aspect or embodiment described herein, the process further comprises separating (e.g. removing or filtering) the one or more cross-cut sage strains from the first sage extract.

In any aspect or embodiment described herein, the process comprises: placing the one or more cross-cut sage strains in a container with boiling edible solvent (e.g. water and/or such as about 6 ounces to about 10 ounces of edible solvent); and steeping (e.g., for about 5 minutes to about 30 minutes, about 8 to about 15 minutes, or about 10 minutes) the one or more course-cut sage stains in the edible solvent to produce a second sage extract.

In any aspect or embodiment described herein, the process further comprises combining the first sage extract and the second sage extract to produce a combined sage extract.

In any aspect or embodiment described herein, the process further comprises separating (e.g. removing or filtering) the one or more cross-cut sage strains from the second sage extract prior to combine the first sage extract and the second sage extract.

In any aspect or embodiment described herein, the process further comprises removing (e.g. removing or filtering) the one or more cross-cut sage strains from the combined sage extract.

In any aspect or embodiment described herein, the container is a sealable container (e.g., a container that can produce an airtight seal and/or water tight seal, such as at a temperature of up to about 100° C.), and the method further comprises sealing the container prior to incubating the edible solvent and the one or more course cut sage strains.

In any aspect or embodiment described herein, the process further comprises adding and/or mixing (e.g. stirring or shaking) one or more (e.g., 1, 2, 3, 4, 5, 6, 7, 8, or more) of the following to the first sage extract or the combined sage extract: (i) one or more (e.g., 1, 2, 3, 4, 5, 6, 7, 8, or more) sweetener (e.g. stevia leaf extract), (ii) one or more (e.g., 1, 2, 3, 4, 5, 6, 7, 8, or more) preservative (e.g. citric acid), (iii) one or more (e.g., 1, 2, 3, 4, 5, 6, 7, 8, or more) taste-masking agent (e.g. one or more fruit juice, such as one or more (e.g., 1, 2, 3, 4, 5, 6, 7, 8, or more) fruit juices that includes fruit juice that includes pear juice, white grape juice, apple juice, peach juice, or a mixture thereof), (iv) one or more (e.g., 1, 2, 3, 4, 5, 6, 7, 8, or more) antioxidant, (v) one or more (e.g., 1, 2, 3, 4, 5, 6, 7, 8, or more) pH modifier, or (vi) a mixture thereof.

In any aspect or embodiment described herein, the one or more sweetener includes or is stevia leaf extract.

In any aspect or embodiment described herein, the one or more preservative includes or is citric acid.

In any aspect or embodiment described herein, the one or more taste-masking agent includes pear juice, white grape juice, apple juice, peach juice, or a mixture thereof.

In any aspect or embodiment described herein, the stevia leaf extract is added in an amount of about 0.1 to about 0.2 ounces (e.g., about 0.1 to about 0.2, about 0.1 to about 0.18, about 0.1 to about 0.16, about 0.1 to about 0.14, about 0.12 to about 0.2, about 0.12 to about 0.18, about 0.12 to about 0.16, about 0.14 to about 0.2, about 0.14 to about 0.18, about 0.16 to about 0.2, or about 0.16 to about 0.2) per 8 ounces of the first sage extract or the combined sage extract

In any aspect or embodiment described herein, the pear juice is added in an amount of about 0.5 ounces to about 1.5 ounces (e.g., about 0.5 to about 1.5, about 0.5 to about 1.25, about 0.5 to about 1.0, about 0.5 to about 0.75 ounces, about 0.75 to about 1.5, about 0.75 to about 1.25, about 0.75 to about 1.0, about 1.0 to about 1.5, about 1.0 to about 1.25, or about 1.25 to about 1.5 ounces) of a reconstituted pear juice concentrate that is about 5.0 to about 8.0 parts (e.g., about 5.0 to about 8.0, about 5.0 to about 7.5, about 5.0 to about 7.0, about 5.0 to about 6.5, about 5.0 to about 6.0, about 5.5 to about 8.0, about 5.5 to about 7.5, about 5.5 to about 7.0, about 5.5 to about 6.5, about 6.0 to about 8.0, about 6.0 to about 7.5, about 6.0 to about 7.0, about 6.0 to about 8.0, about 6.0 to about 7.5, about 6.0 to about 7.0, about 6.5 to about 8.0, about 6.5 to about 7.5, or about 7.0 to about 8.0 parts) water per about 1 part of pear juice concentrate.

In any aspect or embodiment described herein, the white grape juice is added in an amount of about 0.5 ounces to about 1.5 ounces (e.g., about 0.5 to about 1.5, about 0.5 to about 1.25, about 0.5 to about 1.0, about 0.5 to about 0.75 ounces, about 0.75 to about 1.5, about 0.75 to about 1.25, about 0.75 to about 1.0, about 1.0 to about 1.5, about 1.0 to about 1.25, or about 1.25 to about 1.5 ounces) of a reconstituted white grape juice concentrate that is about 3.5 to about 5.0 parts (e.g., about 3.5 to about 5, about 3.5 to about 4.5, about 3.5 to about 4.0, about 4.0 to about 5, about 4.0 to about 4.5, or about 4.5 to about 5 parts) water per about 1 part of white grape juice concentrate.

In any aspect or embodiment described herein, the apple juice is added in an amount of about 0.5 ounces to about 1.5 ounces (e.g., about 0.5 to about 1.5, about 0.5 to about 1.25, about 0.5 to about 1.0, about 0.5 to about 0.75 ounces, about 0.75 to about 1.5, about 0.75 to about 1.25, about 0.75 to about 1.0, about 1.0 to about 1.5, about 1.0 to about 1.25, or about 1.25 to about 1.5 ounces) of a reconstituted apple juice concentrate that is about 5.0 to about 8.5 parts (e.g., about 5.0 to about 8.5, about 5.0 to about 8.0, about 5.0 to about 7.5, about 5.0 to about 7.0, about 5.0 to about 6.5, about 5.0 to about 6.0, about 5.5 to about 8.5, about 5.5 to about 8.0, about 5.5 to about 7.5, about 5.5 to about 7.0, about 5.5 to about 6.5, about 6.0 to about 8.5, about 6.0 to about 8.0, about 6.0 to about 7.5, about 6.0 to about 7.0, about 6.0 to about 8.5, about 6.0 to about 8.0, about 6.0 to about 7.5, about 6.0 to about 7.0, about 6.5 to about 8.5, about 6.5 to about 8.0, about 6.5 to about 7.5, about 7.0 to about 8.5, about 7.0 to about 8.0, or about 7.5 to about 8.5 parts) water per about 1 part of apple juice concentrate.

In any aspect or embodiment described herein, the peach juice is added in an amount of about 0.5 ounces to about 1.5 ounces (e.g., about 0.5 to about 1.5, about 0.5 to about 1.25, about 0.5 to about 1.0, about 0.5 to about 0.75 ounces, about 0.75 to about 1.5, about 0.75 to about 1.25, about 0.75 to about 1.0, about 1.0 to about 1.5, about 1.0 to about 1.25, or about 1.25 to about 1.5 ounces) of a reconstituted pear juice concentrate that is about 5.0 to about 8.5 parts (e.g., about 5.0 to about 8.5, about 5.0 to about 8.0, about 5.0 to about 7.5, about 5.0 to about 7.0, about 5.0 to about 6.5, about 5.0 to about 6.0, about 5.5 to about 8.5, about 5.5 to about 8.0, about 5.5 to about 7.5, about 5.5 to about 7.0, about 5.5 to about 6.5, about 6.0 to about 8.5, about 6.0 to about 8.0, about 6.0 to about 7.5, about 6.0 to about 7.0, about 6.0 to about 8.5, about 6.0 to about 8.0, about 6.0 to about 7.5, about 6.0 to about 7.0, about 6.5 to about 8.5, about 6.5 to about 8.0, about 6.5 to about 7.5, about 7.0 to about 8.5, about 7.0 to about 8.0, or about 7.5 to about 8.5 parts) water per about 1 part of pear juice concentrate.

In any aspect or embodiment described herein, the process further comprises preparing the reconstituted pear juice concentrate by reconstituting about 1 part of the pear juice concentrate with about 5 to about 8 parts (e.g., about 5.0 to about 8.0, about 5.0 to about 7.5, about 5.0 to about 7.0, about 5.0 to about 6.5, about 5.0 to about 6.0, about 5.5 to about 8.0, about 5.5 to about 7.5, about 5.5 to about 7.0, about 5.5 to about 6.5, about 6.0 to about 8.0, about 6.0 to about 7.5, about 6.0 to about 7.0, about 6.0 to about 8.0, about 6.0 to about 7.5, about 6.0 to about 7.0, about 6.5 to about 8.0, about 6.5 to about 7.5, or about 7.0 to about 8.0 parts) water.

In any aspect or embodiment described herein, the process further comprises preparing the reconstituted white grape juice concentrate by reconstituting about 1 part of the white grape juice concentrate with about 3.5 to about 5 parts (e.g., about 3.5 to about 5, about 3.5 to about 4.5, about 3.5 to about 4.0, about 4.0 to about 5, about 4.0 to about 4.5, or about 4.5 to about 5 parts) water.

In any aspect or embodiment described herein, the process further comprises preparing the reconstituted apple juice concentrate by reconstituting about 1 part of the apple juice concentrate with about 5 to about 8.5 parts (e.g., about 5.0 to about 8.5, about 5.0 to about 8.0, about 5.0 to about 7.5, about 5.0 to about 7.0, about 5.0 to about 6.5, about 5.0 to about 6.0, about 5.5 to about 8.5, about 5.5 to about 8.0, about 5.5 to about 7.5, about 5.5 to about 7.0, about 5.5 to about 6.5, about 6.0 to about 8.5, about 6.0 to about 8.0, about 6.0 to about 7.5, about 6.0 to about 7.0, about 6.0 to about 8.5, about 6.0 to about 8.0, about 6.0 to about 7.5, about 6.0 to about 7.0, about 6.5 to about 8.5, about 6.5 to about 8.0, about 6.5 to about 7.5, about 7.0 to about 8.5, about 7.0 to about 8.0, or about 7.5 to about 8.5 parts) water.

In any aspect or embodiment described herein, the process further comprises preparing the reconstituted pear juice concentrate by reconstituting about 1 part of the pear juice concentrate with about 5 to about 8.5 parts (e.g., about 5.0 to about 8.5, about 5.0 to about 8.0, about 5.0 to about 7.5, about 5.0 to about 7.0, about 5.0 to about 6.5, about 5.0 to about 6.0, about 5.5 to about 8.5, about 5.5 to about 8.0, about 5.5 to about 7.5, about 5.5 to about 7.0, about 5.5 to about 6.5, about 6.0 to about 8.5, about 6.0 to about 8.0, about 6.0 to about 7.5, about 6.0 to about 7.0, about 6.0 to about 8.5, about 6.0 to about 8.0, about 6.0 to about 7.5, about 6.0 to about 7.0, about 6.5 to about 8.5, about 6.5 to about 8.0, about 6.5 to about 7.5, about 7.0 to about 8.5, about 7.0 to about 8.0, or about 7.5 to about 8.5 parts) water.

In any aspect or embodiment described herein, the one or more sweetener includes saccharin, aspartame, acesulfame K, neotame, sodium saccharin, sucralose, trehalose, tagatose, mannitol, sorbitol, xylitol, erythritol, maltitol, sucrose, fructose, acacia syrup, alitame, sodium chloride, neohesperidine dihydrochalcone, magnesium chloride, disodium inosinate, sodium L-glutamate, honey, cyclamate, cylamate, dextrose, calcium citrate, glycyrrhizin, sucrose, sugar, monosaccharides, oligosaccharides, aldose, ketose, maltose, lactose, xylitol, D-sorbitol, pentitol, hexitol, malitol, sodium cyclamate, maltol, mannitol, sorbitol, sylitol, isomalt, inulin, Prosweet® Powder, safrole, stevia or stevia leaf extract, thaumatin, talin, monoammonium glyrrhizinate, glucose, or a mixture thereof.

In any aspect or embodiment described herein, the one or more taste-masking agent includes cranberry juice, pomegranate juice, pineapple juice, camerise juice, blackcurrant juice, redcurrant juice, blueberry juice, blackberry juice, strawberry juice, raspberry juice, acai juice, acerola juice, goji berry juice, cynorhodon juice, arbutus juice, myrtle juice, guarana juice, coffee berry juice, cola nuts juice, maracuja juice, goyava juice, mango juice, apple juice, pear juice, peach juice, plume juice, blood-orange grapefruit juice, lemon juice, lime juice, mandarin juice, clementine juice, tangerine juice, or a mixture thereof.

In any aspect or embodiment described herein, the one or more taste-masking agent includes essential oil, peppermint oil, menthol, spearmint oil, citrus oil, cinnamon oil, strawberry flavor, cherry flavor, raspberry flavor, orange oil, apple, pear, peach, banana, Bavarian cream, caramel, cherry cream, chocolate, cinnamon, bubble gum, citrus, citrus punch, citrus cream, cotton candy, cocoa, cool cherry, camphor, cool citrus, eucalyptus, fruit punch, ginger, spearmint, spearmint cream, glycyrrhetinate, glycyrrhiza (licorice) syrup, grape, lemon, lemon cream, honey-lemon, lemon-lime, lemon-mint, lime, root beer, tutti frutti, walnut, watermelon, rum, anise, black currant, butterscotch, orange, cola, Swiss cream, mandarine, tangerine, grapefruit, vanilla, berry, mixed berry, raspberry, strawberry cream, wild cherry, maple, marshmallow, mint cream, wintergreen, peppermint flavors, peppermint cream, methyl salicylate, eugenol, or a mixture thereof.

In any aspect or embodiment described herein, the one or more taste-masking agent includes acetaldehyde (apple), benzaldehyde (cherry, almond), cinnamic aldehyde (cinnamon), citral, alpha citral (lemon, lime), neral, beta citral (lemon, lime), decanal (orange, lemon), ethyl vanillin (vanilla, cream), heliotropine, piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), trans-2 hexenal (berry fruits), tolyl aldehyde (cherry, almond), veratraldehyde (vanilla), 2,6-dimethyl-5-heptenal, melonal (melon), 2-6-dimethyloctanal (green fruit), 2-dodecenal (citrus, mandarin), or a mixture thereof.

In any aspect or embodiment described herein, the one or more preservative includes citric acid, benzoic acid, sodium benzoate, sorbic acid, sodium carboxymethylcellulose, potassium sorbate, ascorbic acid, or a mixture thereof.

In any aspect or embodiment described herein, the one or more antioxidant includes butylated hydroxyanisole (BHA), butylated hydroxytoluene (BHT), ascorbic acid, methionine, sodium ascorbate, sodium thiosulfate, sodium bisulfite, sodium metabisulfite, ascorbyl palmitate, thioglycerol, alpha tocopherol (vitamin E), cysteine hydrochloride, or a mixture thereof.

In any aspect or embodiment described herein, the one or more pH modifier includes hydrochloric acid, citric acid, fumaric acid, lactic acid, sodium hydroxide, mono sodium phosphate, dibasic sodium phosphate, amino acids, sodium citrate, sodium bicarbonate, sodium carbonate, ammonium carbonate, or a mixture thereof.

In any aspect or embodiment described herein, the beverage further comprises an additive selected from essential oil, cedar oil, chlorophyll, grape seed extract, pine bark oil, resveratrol, vanilla, chia seeds, collagen, fiber (e.g. wheat dextrin, psyllium, methylcellulose, inulin, etc.), acai, amia fruit, artichoke, asparagus, avocado, banana, barley grass, blueberry, beet, blackberry, carrot, celery, cherry, coconut, cordyceps, cranberry, cucumber, fruit juice powder, garlic, ginger root, ginseng, grape, grapefruit, guarana, honey, kale, kava root, lemon, lime, lion's mane, mango, natural flavors, nettle leaf, noni, orange, pineapple, pomegranate, raspberry, reishi, rose, spinach, strawberry, sweet grass, watermelon, wheatgrass, Ashwagandha, black tea, mint, sumac, green tea, lavender, hemp, parsley leaf, matcha, rosemary, sassafras, turmeric, yerba mate, cinnamon, amino acids, caffeine, calcium, carbon, glutathione, electrolytes, cannabidiol (CBD), fulvic acid, protein, sea salt, vitamins, zinc, probiotics, hydrogen, and a mixture thereof.

Method of Making the Beverage

In a further aspect, the present disclosure provides a method of making a beverage or nutritional beverage. The method comprises adding boiling edible solvent (e.g. water and/or such as about 6 ounces to about 10 ounces of edible solvent) and one or more course-cut sage strains (e.g., about 1 mm to about 10 mm or about 4 mm to about 10 mm) comprising Salvia lavandulifolia (e.g. further comprises Salvia apiana, Salvia officianalis, or a mixture thereof) to a container; and steeping (e.g., for about 5 minutes to about 30 minutes, about 8 to about 15 minutes, or about 10 minutes) the one or more course-cut sage stains in the edible solvent to produce a first sage extract.

In any aspect or embodiment described herein, the one or more course-cut sage strains comprises a mixture of sage strains (e.g., 2, 3, 4, 5, 6, 7, or more sage strains). For example, in any aspect or embodiment described herein, the one or more cross-cut sage stains further comprises one or more of the following Salvia apiana, Salvia officianalis, or a mixture thereof.

In any aspect or embodiment described herein, there is about 6 ounces to about 10 ounces of edible solvent, about 0.5 to about 2.5 tablespoons of the course cut sage, or a mixture thereof.

In any aspect or embodiment described herein, the method further comprises separating (e.g. removing or filtering) the one or more cross-cut sage strains from the first sage extract.

In any aspect or embodiment described herein, the method further comprises placing the one or more cross-cut sage strains in a container with boiling edible solvent (e.g. water and/or such as about 6 ounces to about 10 ounces of edible solvent), and steeping (e.g., for about 5 minutes to about 30 minutes, about 8 to about 15 minutes, or about 10 minutes) the one or more course-cut sage stains in the edible solvent to produce a second sage extract.

In any aspect or embodiment described herein, the method further comprises combining the first sage extract and the second sage extract to produce a combined sage extract.

In any aspect or embodiment described herein, the method further comprises separating (e.g. removing or filtering) the one or more cross-cut sage strains from the second sage extract prior to combine the first sage extract and the second sage extract.

In any aspect or embodiment described herein, the method further comprises removing (e.g. removing or filtering) the one or more cross-cut sage strains from the combined sage extract.

In any aspect or embodiment described herein, the container is a sealable container (e.g., airtight seal and/or watertight seal, such as at a temperature of up to about 100° C.), and the method further comprises sealing the container prior to incubating the edible solvent and the one or more course cut sage strains.

In any aspect or embodiment described herein, the method further comprises adding and/or mixing (e.g. stirring or shaking) one or more sweetener (e.g. stevia leaf extract) to the first sage extract or the combined sage extract.

In any aspect or embodiment described herein, the method further comprises adding and/or mixing (e.g. stirring or shaking) one or more preservative (e.g. citric acid, benzoic acid, sodium benzoate, sorbic acid, sodium carboxymethylcellulose, potassium sorbate, ascorbic acid, or a mixture thereof) to the first sage extract or the combined sage extract.

In any aspect or embodiment described herein, the method further comprises adding and/or mixing (e.g. stirring or shaking) one or more taste-masking agent (e.g. fruit juice, such as fruit juice that includes pear juice, white grape juice, apple juice, peach juice, or a mixture thereof) to the first sage extract or the combined sage extract.

In any aspect or embodiment described herein, the one or more sweetener includes stevia leaf extract. In any aspect or embodiment described herein, the one or more preservative includes citric acid. In any aspect or embodiment described herein, the one or more taste-masking agent includes pear juice, white grape juice, apple juice, peach juice, or a mixture thereof.

In any aspect or embodiment described herein, the stevia leaf extract is added in an amount of about 0.1 to about 0.2 ounces per 8 ounces of the first sage extract or the combined sage extract.

In any aspect or embodiment described herein, the pear juice is added in an amount of about 0.5 ounces to about 1.5 ounces of a reconstituted pear juice concentrate that is about 5 to about 8 parts water per 1 part of pear juice concentrate.

In any aspect or embodiment described herein, the white grape juice is added in an amount of about 0.5 ounces to about 1.5 ounces of a reconstituted white grape juice concentrate that is about 3.5 to about 5 parts water per 1 part of white grape juice concentrate.

In any aspect or embodiment described herein, the apple juice is added in an amount of about 0.5 ounces to about 1.5 ounces of a reconstituted apple juice concentrate that is about 5 to about 8.5 parts water per 1 part of apple juice concentrate.

In any aspect or embodiment described herein, the peach juice is added in an amount of about 0.5 ounces to about 1.5 ounces of a reconstituted pear juice concentrate that is about 5 to about 8.5 parts water per 1 part of pear juice concentrate.

In any aspect or embodiment described herein,

In any aspect or embodiment described herein, the method further comprises preparing the reconstituted pear juice concentrate by reconstituting 1 part of the pear juice concentrate with about 5 to about 8 parts water.

In any aspect or embodiment described herein, the method further comprises preparing the reconstituted white grape juice concentrate by reconstituting 1 part of the white grape juice concentrate with about 3.5 to about 5 parts water.

In any aspect or embodiment described herein, the method further comprises preparing the reconstituted apple juice concentrate by reconstituting 1 part of the apple juice concentrate with about 5 to about 8.5 parts water.

In any aspect or embodiment described herein, the method further comprises preparing the reconstituted pear juice concentrate by reconstituting 1 part of the pear juice concentrate with about 5 to about 8.5 parts water.

In any aspect or embodiment described herein, the one or more sweetener includes saccharin, aspartame, acesulfame K, neotame, sodium saccharin, sucralose, trehalose, tagatose, mannitol, sorbitol, xylitol, erythritol, maltitol, sucrose, fructose, acacia syrup, alitame, sodium chloride, neohesperidine dihydrochalcone, magnesium chloride, disodium inosinate, sodium L-glutamate, honey, cyclamate, cylamate, dextrose, calcium citrate, glycyrrhizin, sucrose, sugar, monosaccharides, oligosaccharides, aldose, ketose, maltose, lactose, xylitol, D-sorbitol, pentitol, hexitol, malitol, sodium cyclamate, maltol, mannitol, sorbitol, sylitol, isomalt, inulin, Prosweet® Powder, safrole, stevia or stevia leaf extract, thaumatin, talin, monoammonium glyrrhizinate, glucose, or a mixture thereof.

In any aspect or embodiment described herein, the one or more taste-masking agent includes cranberry juice, pomegranate juice, pineapple juice, camerise juice, blackcurrant juice, redcurrant juice, blueberry juice, blackberry juice, strawberry juice, raspberry juice, acai juice, acerola juice, goji berry juice, cynorhodon juice, arbutus juice, myrtle juice, guarana juice, coffee berry juice, cola nuts juice, maracuja juice, goyava juice, mango juice, apple juice, pear juice, peach juice, plume juice, blood-orange grapefruit juice, lemon juice, lime juice, mandarin juice, clementine juice, tangerine juice, or a mixture thereof.

In any aspect or embodiment described herein, the one or more taste-masking agent includes essential oil, peppermint oil, menthol, spearmint oil, citrus oil, cinnamon oil, strawberry flavor, cherry flavor, raspberry flavor, orange oil, apple, pear, peach, banana, Bavarian cream, caramel, cherry cream, chocolate, cinnamon, bubble gum, citrus, citrus punch, citrus cream, cotton candy, cocoa, cool cherry, camphor, cool citrus, eucalyptus, fruit punch, ginger, spearmint, spearmint cream, glycyrrhetinate, glycyrrhiza (licorice) syrup, grape, lemon, lemon cream, honey-lemon, lemon-lime, lemon-mint, lime, root beer, tutti frutti, walnut, watermelon, rum, anise, black currant, butterscotch, orange, cola, Swiss cream, mandarine, tangerine, grapefruit, vanilla, berry, mixed berry, raspberry, strawberry cream, wild cherry, maple, marshmallow, mint cream, wintergreen, peppermint flavors, peppermint cream, methyl salicylate, eugenol, or a mixture thereof.

In any aspect or embodiment described herein, the one or more taste-masking agent includes acetaldehyde (apple), benzaldehyde (cherry, almond), cinnamic aldehyde (cinnamon), citral, alpha citral (lemon, lime), neral, beta citral (lemon, lime), decanal (orange, lemon), ethyl vanillin (vanilla, cream), heliotropine, piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), trans-2 hexenal (berry fruits), tolyl aldehyde (cherry, almond), veratraldehyde (vanilla), 2,6-dimethyl-5-heptenal, melonal (melon), 2-6-dimethyloctanal (green fruit), 2-dodecenal (citrus, mandarin), or a mixture thereof.

In any aspect or embodiment described herein, the one or more preservative includes citric acid, benzoic acid, sodium benzoate, sorbic acid, sodium carboxymethylcellulose, potassium sorbate, ascorbic acid, or a mixture thereof.

In any aspect or embodiment described herein, the one or more antioxidant includes butylated hydroxyanisole (BHA), butylated hydroxytoluene (BHT), ascorbic acid, methionine, sodium ascorbate, sodium thiosulfate, sodium bisulfite, sodium metabisulfite, ascorbyl palmitate, thioglycerol, alpha tocopherol (vitamin E), cysteine hydrochloride, or a mixture thereof.

In any aspect or embodiment described herein, the one or more pH modifier includes hydrochloric acid, citric acid, fumaric acid, lactic acid, sodium hydroxide, mono sodium phosphate, dibasic sodium phosphate, amino acids, sodium citrate, sodium bicarbonate, sodium carbonate, ammonium carbonate, or a mixture thereof.

In any aspect or embodiment described herein, the beverage further comprises an additive selected from essential oil, cedar oil, chlorophyll, grape seed extract, pine bark oil, resveratrol, vanilla, chia seeds, collagen, fiber (e.g. wheat dextrin, psyllium, methylcellulose, inulin, etc.), acai, amia fruit, artichoke, asparagus, avocado, banana, barley grass, blueberry, beet, blackberry, carrot, celery, cherry, coconut, cordyceps, cranberry, cucumber, fruit juice powder, garlic, ginger root, ginseng, grape, grapefruit, guarana, honey, kale, kava root, lemon, lime, lion's mane, mango, natural flavors, nettle leaf, noni, orange, pineapple, pomegranate, raspberry, reishi, rose, spinach, strawberry, sweet grass, watermelon, wheatgrass, Ashwagandha, black tea, mint, sumac, green tea, lavender, hemp, parsley leaf, matcha, rosemary, sassafras, turmeric, yerba mate, cinnamon, amino acids, caffeine, calcium, carbon, glutathione, electrolytes, cannabidiol (CBD), fulvic acid, protein, sea salt, vitamins, zinc, probiotics, hydrogen, and a mixture thereof.

Therapeutic Methods

The description provides therapeutic beverages as described herein for effectuating the treatment of, amelioration of, prevention of, or decrease the likelihood of developing a disease, e.g., cancer, heart disease, atherosclerosis, stroke, periodontitis, cavities, gingivitis, tooth loss. Thus, in an additional aspect, the description provides therapeutic beverage as described herein. For example, a therapeutic beverage comprising an edible solvent (e.g. water) and an extract from one or more sage strains comprising Salvia lavandulifolia (e.g., an extract from the leaves of one or more sage strains comprising Salvia lavandulifolia).

The terms “treat”, “treating”, and “treatment”, etc., as used herein, refer to any action providing a benefit to a patient for which the present compounds may be administered, including the treatment of any disease state or condition which is benefited by the beverage of the present disclosure.

In a further aspect, the description provides methods for treating, ameliorating, or decreasing the likelihood of developing a disease, disorder, or one or more symptom thereof, in a subject or patient, e.g., an animal such as a human, comprising administering to a subject in need thereof a beverage or nutritional beverage described herein, wherein the beverage or nutritional beverage is effective for treating, ameliorating, or decreasing the likelihood of developing the disease, disorder, or one or more symptom of a disease or disorder in the subject.

In an additional aspect, the present disclosure provides a method of treating a patient (such as a human patient) in need for a disease state or condition or decreasing the likelihood of a patient (such as a human patient) to develop a disease state or condition, the method comprising administering to a patient in need an effective amount of a nutritional beverage according to the present disclosure.

An “effective amount” of beverage of the present disclosure is an amount needed to achieve a desired pharmacologic effect or therapeutic improvement without undue adverse side effects. The effective amount of beverage will be selected by those skilled in the art depending on the particular patient and the type of conditions being treated. It is understood that “an effective amount” or “a therapeutically effective amount” can vary from patient to patient, due to variation in general condition of the subject, the condition being treated, and the severity of the condition being treated. When discussing a method of treating a disease or disorder, an effective amount includes an amount effective to have a statistically significant and favorable effect on the rate of the patient's disease or disorder over time or on a level of biological marker of the disease or disorder.

In another aspect, the description provides a beverage or nutritional beverage of the present disclosure for use in a method of treating, ameliorating, or decreasing the likelihood of the development of, a disease or disorder in a subject, the method comprising administering the beverage to a subject in need thereof, wherein the beverage is effective in treating or ameliorating at least one symptom of the disease or disorder, or the likelihood of developing a disease or disorder.

### EXAMPLES

An exemplary nutritional beverage according to the present disclosure was prepared the following exemplary process.
(a) Plant parts from organic herbs comprising Salvia lavandulifolia, Salvia apiana, and Salvia officianalis were acquired and cut to herbal industry standard coarse cut size (e.g. about 6 mm to about 8 mm).
(b) The cut herbs were blended in a 38:1:1 ratio of Salvia lavandulifolia, Salvia apiana, and Salvia officianalis.
(c) One tablespoon of the sage mixture of step (d) was added to a container capable of providing an airtight seal at a temperature of about 208° F. to about 210° F. (e.g., about 97° C. to about 99° C.).
(d) Spring water (8 ounces) at a temperature of about 200° F. to about 210° F. (e.g., about 93° C. to about 99° C.) was added to the container of comprising the sage mixture of step (c).
(e) The container was sealed with an airtight compression seal, and the mixture steeped/incubated for 10 minutes (first extraction), extracting the complete botanicals from the sage mixture for optimal taste and health benefits.
(f) The brewed extract of step (e) was filtered into another container, and the sage mixture placed in a container capable of providing an airtight seal at a temperature of about 208° F. to about 210° F. (e.g., about 97° C. to about 99° C.) for a second extraction.
(g) Spring water (8 ounces) at a temperature of about 200° F. to about 210° F. (e.g., about 93° C. to about 99° C.) was added to the container with the once-extracted sage mixture.
(h) The container was sealed with an airtight compression seal, and the mixture was steeped/incubated for 10 minutes (second extraction).
(i) The brewed extract of step (h) was filtered and combined with the filtered extract of step (f); the twice-extracted sage mixture was discarded.
(j) Organic stevia extract was added to the combined filtered extract (0.1575 ounces per 8 ounces of brewed extract).
(k) Juice extracts were prepared as follows:
   1 part organic pear juice concentrate was reconstituted with 6.51 parts spring water;
   1 part organic white grape juice concentrate was reconstituted with 4.33 parts spring water;
   1 part organic apple juice concentrate was reconstituted with 6.86 parts spring water; and
   1 part organic peach juice concentrated was reconstituted with 6.83 parts spring water.
(l) One ounce of each of the prepared juice extracts (i.e., pear juice, white grape juice, apple juice, and peach juice) was added per 8 ounces of combined filtered extract from step (j).

A 77-year-old male patient presented with symptoms of debilitating hip pain that was not associated with an acute trauma. Patient was unable to walk and spent several weeks in the hospital and a rehabilitation center. The patient was discharged without the debilitating hip pain being alleviated. After leaving the rehabilitation center, the patient was only able to take a few steps per day with the aid of a walker. Patient reported that the pain was considerably worse on damp days. The patient was administered 8 ounces per day of an exemplary nutritional beverage as described herein for 90 days. At the end of 90 days, the patient was reevaluated. The patient reported (1) experiencing a significant decrease in pain, (2) the cessation of pain on damp days, (3) the ability to walk unassisted, and (4) the ability to resume his normal daily activities. At the end of the 90 days, the patient stepped-down the consumption of the exemplary nutritional beverage by taking 8 ounces every other day for 6 months. During this period, the patient continued to be pain free. At the end of the 6 months, the patient stopped consuming the exemplary nutritional beverage. After the cessation of the consumption of the exemplary nutritional beverage, the patient did not observe a decline in the benefits observed. These results demonstrate that the exemplary nutritional beverage was capable of significantly reducing pain in the patient, presumably through decreased inflammation.

A 56-year-old male patient presented with symptoms of rheumatoid arthritis joint pain for several years. Patient was a restaurant owner and chef who spent long hours on his feet and used his hands continuously for work related items. The patient was treated in the hospital for his pain and was prescribed a tumor necrosis factor (TNF) inhibitor. A workplace injury to his hand coupled with the immune suppression associated with the TNF inhibitor resulted in a severe infection, and amputation of his hand was considered. The patient was no longer able to work due joint pain and the infection. The patient was administered 8 ounces of an exemplary nutritional beverage, twice a day, as described herein for 30 days. At the end of 30 days, the patient was reevaluated. The patient reported (1) experiencing a significant reduction of joint pain, (2) the severe hand infection subsided, and (3) the ability to resume his normal career as a restaurant owner and chef. At the end of the 30 days, the patient stepped-down the consumption of the exemplary nutritional beverage by taking 8 ounces once per day for 3 months. During this period, the patient reported no rheumatoid arthritis flare ups and the infection in his hand was gone. These results demonstrate that the exemplary nutritional beverage was capable of significantly reducing arthritis joint pain and infection in the patient, presumably through decreased inflammation, as well as the antioxidant and antiviral effects.

The contents of all references, patents, pending patent applications and published patents, cited throughout this application are hereby expressly incorporated by reference.

Those skilled in the art will recognize or be able to ascertain using no more than routine experimentation, many equivalents to the specific embodiments of the disclosure described herein. Such equivalents are intended to be encompassed by the following claims. It is understood that the detailed examples and embodiments described herein are given by way of example for illustrative purposes only and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed is:

1. A beverage comprising:
an edible solvent (e.g. water); and
an extract from one or more sage strains comprising Salvia lavandulifolia.

2. The beverage of claim 1, wherein the one or more sage strains comprises a mixture of sage strains (e.g., 2, 3, 4, 5, 6, 7, or more sage strains).

3. The beverage of claim 1, wherein the one or more sage stains further comprises one or more of the following Salvia apiana, Salvia officianalis, or a mixture thereof.

4. The beverage of claim 1, wherein the solvent includes water, alkaline water, apple cider vinegar, birch water, cactus water, carbonated water, maple water, mineral water, ocean water, spring water, or a mixture thereof.

5. The beverage of claim 1, further comprising one or more sweetener (e.g. stevia leaf extract), one or more preservative (e.g. citric acid), one or more taste-masking agent (e.g. one or more fruit juices, such as one or more fruit juices that includes fruit juice that includes pear juice, white grape juice, apple juice, peach juice, or a mixture thereof), one or more antioxidant, one or more pH modifier, or a mixture thereof.

6. The beverage of claim 5, wherein the one or more sweetener includes saccharin, aspartame, acesulfame K, neotame, sodium saccharin, sucralose, trehalose, tagatose, mannitol, sorbitol, xylitol, erythritol, maltitol, sucrose, fructose, acacia syrup, alitame, sodium chloride, neohesperidine dihydrochalcone, magnesium chloride, disodium inosinate, sodium L-glutamate, honey, cyclamate, cylamate, dextrose, calcium citrate, glycyrrhizin, sucrose, sugar, monosaccharides, oligosaccharides, aldose, ketose, maltose, lactose, xylitol, D-sorbitol, pentitol, hexitol, malitol, sodium cyclamate, maltol, mannitol, sorbitol, sylitol, isomalt, inulin, Prosweet® Powder, safrole, stevia or stevia leaf extract, thaumatin, talin, monoammonium glyrrhizinate, glucose, or a mixture thereof.

7. The beverage of claim 5, wherein:
(i) the one or more taste-masking agent includes cranberry juice, pomegranate juice, pineapple juice, camerise juice, blackcurrant juice, redcurrant juice, blueberry juice, blackberry juice, strawberry juice, raspberry juice, acai juice, acerola juice, goji berry juice, cynorhodon juice, arbutus juice, myrtle juice, guarana juice, coffee berry juice, cola nuts juice, maracuja juice, goyava juice, mango juice, apple juice, pear juice, peach juice, plume juice, blood-orange grapefruit juice, lemon juice, lime juice, mandarin juice, clementine juice, tangerine juice, or a mixture thereof;
(ii) the one or more taste-masking agent includes essential oil, peppermint oil, menthol, spearmint oil, citrus oil, cinnamon oil, strawberry flavor, cherry flavor, raspberry flavor, orange oil, apple, pear, peach, banana, Bavarian cream, caramel, cherry cream, chocolate, cinnamon, bubble gum, citrus, citrus punch, citrus cream, cotton candy, cocoa, cool cherry, camphor, cool citrus, eucalyptus, fruit punch, ginger, spearmint, spearmint cream, glycyrrhetinate, glycyrrhiza (licorice) syrup, grape, lemon, lemon cream, honey-lemon, lemon-lime, lemon-mint, lime, root beer, tutti frutti, walnut, watermelon, rum, anise, black currant, butterscotch, orange, cola, Swiss cream, mandarine, tangerine, grapefruit, vanilla, berry, mixed berry, raspberry, strawberry cream, wild cherry, maple, marshmallow, mint cream, wintergreen, peppermint flavors, peppermint cream, methyl salicylate, eugenol, or a mixture thereof;
(iii) the one or more taste-masking agent includes acetaldehyde (apple), benzaldehyde (cherry, almond), cinnamic aldehyde (cinnamon), citral, alpha citral (lemon, lime), neral, beta citral (lemon, lime), decanal (orange, lemon), ethyl vanillin (vanilla, cream), heliotropine, piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), trans-2 hexenal (berry fruits), tolyl aldehyde (cherry, almond), veratraldehyde (vanilla), 2,6-dimethyl-5-heptenal, melonal (melon), 2-6-dimethyloctanal (green fruit), 2-dodecenal (citrus, mandarin), or a mixture thereof; or
(iv) a mixture thereof.

8. The beverage of claim 5, wherein:
(i) the one or more preservative includes citric acid, benzoic acid, sodium benzoate, sorbic acid, sodium carboxymethylcellulose, potassium sorbate, ascorbic acid, or a mixture thereof;
(ii) the one or more antioxidant includes butylated hydroxyanisole (BHA), butylated hydroxytoluene (BHT), ascorbic acid, methionine, sodium ascorbate, sodium thiosulfate, sodium bisulfite, sodium metabisulfite, ascorbyl palmitate, thioglycerol, alpha tocopherol (vitamin E), cysteine hydrochloride, or a mixture thereof;
(iii) the one or more pH modifier includes hydrochloric acid, citric acid, fumaric acid, lactic acid, sodium hydroxide, mono sodium phosphate, dibasic sodium phosphate, amino acids, sodium citrate, sodium bicarbonate, sodium carbonate, ammonium carbonate, or a mixture thereof; or
(iv) the beverage further comprises an additive selected from essential oil, cedar oil, chlorophyll, grape seed extract, pine bark oil, resveratrol, vanilla, chia seeds, collagen, fiber (e.g. wheat dextrin, psyllium, methylcellulose, inulin, etc.), acai, amia fruit, artichoke, asparagus, avocado, banana, barley grass, blueberry, beet, blackberry, carrot, celery, cherry, coconut, cordyceps, cranberry, cucumber, fruit juice powder, garlic, ginger root, ginseng, grape, grapefruit, guarana, honey, kale, kava root, lemon, lime, lion's mane, mango, natural flavors, nettle leaf, noni, orange, pineapple, pomegranate, raspberry, reishi, rose, spinach, strawberry, sweet grass, watermelon, wheatgrass, Ashwagandha, black tea, mint, sumac, green tea, lavender, hemp, parsley leaf, matcha, rosemary, sassafras, turmeric, yerba mate, cinnamon, amino acids, caffeine, calcium, carbon, glutathione, electrolytes, cannabidiol (CBD), fulvic acid, protein, sea salt, vitamins, zinc, probiotics, hydrogen, and a mixture thereof; or
(v) a mixture thereof.

9. A beverage produced according to the process:
adding boiling edible solvent (e.g. water) and one or more course-cut sage strains (e.g., about 1 mm to about 10 mm or about 4 mm to about 10 mm) comprising Salvia lavandulifolia to a container; and
steeping (e.g., for about 5 minutes to about 30 minutes, about 8 to about 15 minutes, or about 10 minutes) the one or more course-cut sage stains in the edible solvent to produce a first sage extract.

10. The beverage of claim 9, wherein the one or more course-cut sage strains comprises a mixture of sage strains (e.g., 2, 3, 4, 5, 6, 7, or more sage strains).

11. The beverage of claim 9, wherein the one or more cross-cut sage stains further comprises Salvia apiana, Salvia officinalis, or a mixture thereof.

12. The beverage of claim 9, wherein there is about 6 ounces to about 10 ounces of edible solvent, about 0.5 to about 2.5 tablespoons of the course cut sage, or a mixture thereof.

13. The beverage of claim 9, further comprising separating (e.g. removing or filtering) the one or more cross-cut sage strains from the first sage extract.

14. The beverage of claim 13, further comprising:
placing the one or more cross-cut sage strains in a container with boiling edible solvent (e.g. water and/or such as about 6 ounces to about 10 ounces of edible solvent); and
steeping (e.g., for about 5 minutes to about 30 minutes, about 8 to about 15 minutes, or about 10 minutes) the one or more course-cut sage stains in the edible solvent to produce a second sage extract.

15. The beverage of claim 14, further comprising combining the first sage extract and the second sage extract to produce a combined sage extract.

16. The beverage of claim 15, further comprising (i) separating (e.g. removing or filtering) the one or more cross-cut sage strains from the second sage extract prior to combine the first sage extract and the second sage extract, or (ii) removing (e.g. removing or filtering) the one or more cross-cut sage strains from the combined sage extract.

17. The beverage of claim 9, wherein the container is a sealable container (e.g., a container that can produce an airtight seal and/or water tight seal, such as at a temperature of up to about 100° C.), and the method further comprises sealing the container prior to incubating the edible solvent and the one or more course cut sage strains.

18. The beverage of claim 9, further comprising adding and/or mixing (e.g. stirring or shaking) one or more of the following to the first sage extract or the combined sage extract:
one or more sweetener (e.g. stevia leaf extract);
one or more preservative (e.g. citric acid);
one or more taste-masking agent (e.g. one or more fruit juice, such as one or more fruit juices that includes fruit juice that includes pear juice, white grape juice, apple juice, peach juice, or a mixture thereof);
one or more antioxidant;
one or more pH modifier; or
a mixture thereof.

19. The beverage of claim 18, wherein:
the one or more sweetener includes stevia leaf extract;
the one or more preservative includes citric acid;
the one or more taste-masking agent includes pear juice, white grape juice, apple juice, peach juice, or a mixture thereof; or
a mixture thereof.

20. The beverage of claim 19, wherein
the stevia leaf extract is added in an amount of about 0.1 to about 0.2 ounces per 8 ounces of the first sage extract or the combined sage extract;
the pear juice is added in an amount of about 0.5 ounces to about 1.5 ounces of a reconstituted pear juice concentrate that is about 5 to about 8 parts water per 1 part of pear juice concentrate;
the white grape juice is added in an amount of about 0.5 ounces to about 1.5 ounces of a reconstituted white grape juice concentrate that is about 3.5 to about 5 parts water per 1 part of white grape juice concentrate;
the apple juice is added in an amount of about 0.5 ounces to about 1.5 ounces of a reconstituted apple juice concentrate that is about 5 to about 8.5 parts water per 1 part of apple juice concentrate;
the peach juice is added in an amount of about 0.5 ounces to about 1.5 ounces of a reconstituted pear juice concentrate that is about 5 to about 8.5 parts water per 1 part of pear juice concentrate; or
a mixture thereof.

21. The beverage of claim 20, further comprising:
preparing the reconstituted pear juice concentrate by reconstituting about 1 part of the pear juice concentrate with about 5 to about 8 parts water;
preparing the reconstituted white grape juice concentrate by reconstituting about 1 part of the white grape juice concentrate with about 3.5 to about 5 parts water;
preparing the reconstituted apple juice concentrate by reconstituting about 1 part of the apple juice concentrate with about 5 to about 8.5 parts water;
preparing the reconstituted pear juice concentrate by reconstituting about 1 part of the pear juice concentrate with about 5 to about 8.5 parts water; or
a mixture thereof.

22. The beverage of claim 18, wherein:
(i) the one or more sweetener includes saccharin, aspartame, acesulfame K, neotame, sodium saccharin, sucralose, trehalose, tagatose, mannitol, sorbitol, xylitol, erythritol, maltitol, sucrose, fructose, acacia syrup, alitame, sodium chloride, neohesperidine dihydrochalcone, magnesium chloride, disodium inosinate, sodium L-glutamate, honey, cyclamate, cylamate, dextrose, calcium citrate, glycyrrhizin, sucrose, sugar, monosaccharides, oligosaccharides, aldose, ketose, maltose, lactose, xylitol, D-sorbitol, pentitol, hexitol, malitol, sodium cyclamate, maltol, mannitol, sorbitol, sylitol, isomalt, inulin, Prosweet® Powder, safrole, stevia or stevia leaf extract, thaumatin, talin, monoammonium glyrrhizinate, glucose, or a mixture thereof;
(ii) the one or more taste-masking agent includes cranberry juice, pomegranate juice, pineapple juice, camerise juice, blackcurrant juice, redcurrant juice, blueberry juice, blackberry juice, strawberry juice, raspberry juice, acai juice, acerola juice, goji berry juice, cynorhodon juice, arbutus juice, myrtle juice, guarana juice, coffee berry juice, cola nuts juice, maracuja juice, goyava juice, mango juice, apple juice, pear juice, peach juice, plume juice, blood-orange grapefruit juice, lemon juice, lime juice, mandarin juice, clementine juice, tangerine juice, or a mixture thereof;
(iii) the one or more taste-masking agent includes essential oil, peppermint oil, menthol, spearmint oil, citrus oil, cinnamon oil, strawberry flavor, cherry flavor, raspberry flavor, orange oil, apple, pear, peach, banana, Bavarian cream, caramel, cherry cream, chocolate, cinnamon, bubble gum, citrus, citrus punch, citrus cream, cotton candy, cocoa, cool cherry, camphor, cool citrus, eucalyptus, fruit punch, ginger, spearmint, spearmint cream, glycyrrhetinate, glycyrrhiza (licorice) syrup, grape, lemon, lemon cream, honey-lemon, lemon-lime, lemon-mint, lime, root beer, tutti frutti, walnut, watermelon, rum, anise, black currant, butterscotch, orange, cola, Swiss cream, mandarine, tangerine, grapefruit, vanilla, berry, mixed berry, raspberry, strawberry cream, wild cherry, maple, marshmallow, mint cream, wintergreen, peppermint flavors, peppermint cream, methyl salicylate, eugenol, or a mixture thereof;
(iv) the one or more taste-masking agent includes acetaldehyde (apple), benzaldehyde (cherry, almond), cinnamic aldehyde (cinnamon), citral, alpha citral (lemon, lime), neral, beta citral (lemon, lime), decanal (orange, lemon), ethyl vanillin (vanilla, cream), heliotropine, piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), trans-2 hexenal (berry fruits), tolyl aldehyde (cherry, almond), veratraldehyde (vanilla), 2,6-dimethyl-5-heptenal, melonal (melon), 2-6-dimethyloctanal (green fruit), 2-dodecenal (citrus, mandarin), or a mixture thereof;
(v) the one or more preservative includes citric acid, benzoic acid, sodium benzoate, sorbic acid, sodium carboxymethylcellulose, potassium sorbate, ascorbic acid, or a mixture thereof;
(vi) the one or more antioxidant includes butylated hydroxyanisole (BHA), butylated hydroxytoluene (BHT), ascorbic acid, methionine, sodium ascorbate, sodium thiosulfate, sodium bisulfite, sodium metabisulfite, ascorbyl palmitate, thioglycerol, alpha tocopherol (vitamin E), cysteine hydrochloride, or a mixture thereof;
(vii) the one or more pH modifier includes hydrochloric acid, citric acid, fumaric acid, lactic acid, sodium hydroxide, mono sodium phosphate, dibasic sodium phosphate, amino acids, sodium citrate, sodium bicarbonate, sodium carbonate, ammonium carbonate, or a mixture thereof;
(viii) the beverage further comprises an additive selected from essential oil, cedar oil, chlorophyll, grape seed extract, pine bark oil, resveratrol, vanilla, chia seeds, collagen, fiber (e.g. wheat dextrin, psyllium, methylcellulose, inulin, etc.), acai, amia fruit, artichoke, asparagus, avocado, banana, barley grass, blueberry, beet, blackberry, carrot, celery, cherry, coconut, cordyceps, cranberry, cucumber, fruit juice powder, garlic, ginger root, ginseng, grape, grapefruit, guarana, honey, kale, kava root, lemon, lime, lion's mane, mango, natural flavors, nettle leaf, noni, orange, pineapple, pomegranate, raspberry, reishi, rose, spinach, strawberry, sweet grass, watermelon, wheatgrass, Ashwagandha, black tea, mint, sumac, green tea, lavender, hemp, parsley leaf, matcha, rosemary, sassafras, turmeric, yerba mate, cinnamon, amino acids, caffeine, calcium, carbon, glutathione, electrolytes, cannabidiol (CBD), fulvic acid, protein, sea salt, vitamins, zinc, probiotics, hydrogen, and a mixture thereof; or
(ix) a mixture thereof.

23. A beverage of claim 1 for use in a method of treating a disease or disorder, or decrease the likelihood of developing a disease or disorder, in a subject, the method comprising administering the beverage to a subject in need thereof, wherein the beverage is effective in treating or ameliorating at least one symptom of the disease or disorder and/or in decreasing the likelihood of developing a disease or disorder.

24. A beverage of claim 9 for use in a method of treating a disease or disorder, or decrease the likelihood of developing a disease or disorder, in a subject, the method comprising administering the beverage to a subject in need thereof, wherein the beverage is effective in treating or ameliorating at least one symptom of the disease or disorder and/or in decreasing the likelihood of developing a disease or disorder.

25. A method of making a beverage, the method comprising:
adding boiling edible solvent (e.g. water and/or such as about 6 ounces to about 10 ounces of edible solvent) and one or more course-cut sage strains (e.g., about 1 mm to about 10 mm or about 4 mm to about 10 mm) comprising Salvia lavandulifolia (e.g. further comprises Salvia apiana, Salvia officianalis, or a mixture thereof) to a container; and
steeping (e.g., for about 5 minutes to about 30 minutes, about 8 to about 15 minutes, or about 10 minutes) the one or more course-cut sage stains in the edible solvent to produce a first sage extract.
